(19) United States
(12) Patent Application Publication
(10) Pub. No.: US 2007/0207025 A1
(43) Pub. Date: Sep. 6, 2007

(54) Tiltable bucket attachment

(76) Inventor: Clint Nesseth, Barron, WI (US)

Correspondence Address: MERCHANT & GOULD PC, P.O. BOX 2903, MINNEAPOLIS, MN, 55402-0903, US

(21) Appl. No.: 11/526,157

(22) Filed: Sep. 22, 2006

Related U.S. Application Data
(60) Provisional application No. 60/719,746, filed on Sep. 22, 2005.

(51) Int. Cl. B66C 23/00

(52) U.S. Cl. 414/724

(57) ABSTRACT

An implement attachment for a motor vehicle is disclosed. The implement attachment includes a hitch assembly and an implement assembly. The hitch assembly includes a first locking structure and a second locking structure, the first locking structure constructed for removably coupling the hitch assembly to the vehicle. The implement assembly includes an interlock structure that mates with the second locking structure of the hitch assembly to removably couple the implement assembly to the hitch assembly. The implement assembly includes an implement with a working surface that defines a top edge. The implement assembly is pivotally tiltable relative to the motor vehicle along a plane extending from a right side of the vehicle to the left side. The implement assembly is pivotally tiltable about a pivot point located above the top edge of the working surface of the implement.

This application is a utility patent application claiming priority to the provisional U.S. Patent Application Ser. No. 60/598,746 filed on Sep. 22, 2005, which application is incorporated herein by reference.

### FIELD OF THE INVENTION

This invention relates generally to landscaping and construction equipment and more particularly to an improved tiltable implement attachment such as a tiltable bucket attachment, a tiltable blade attachment or the like for a vehicle such as a skid steerer, tractor or the like.

### BACKGROUND OF THE INVENTION

A wide variety of implement attachments such as buckets or blades for vehicles such as skid steerers, tractors or the like for landscaping and construction are available and in use. One type of an implement attachment configuration that is in use includes a bucket that is tiltable along a vertical, lateral plane, wherein the sides of the bucket can be tilted up or down vertically. These types of bucket attachments are particularly useful in finish grading, leveling, digging trenches, creating waterways and other applications where a precise contour is critical.

Various tiltable bucket attachment configurations can be found in U.S. Pat. Nos. 6,360,459; 5,964,301; 5,732,781; 5,403,144; and 4,999,022. The designs disclosed in these patents suffer from certain shortcomings. One shortcoming is that some of the designs found in the prior art are fairly complex, requiring a great amount of effort and time in attaching and detaching the implements to and from the vehicles. Another shortcoming is that in prior art bucket configurations, the pivot point about which the bucket is tilted is vertically located behind the bucket. With such a design, the sides of the bucket are simply just tilted up and down and remain at substantially the same distance or radius from the center point of the vehicle as compared to the untilted positions. Thus, for an implement having a large width, for example, one that extends well beyond the width of the vehicle, the tilted side edge will remain outside the outer perimeter of the vehicle. For such configurations, when the tilted side is engaged with the ground, the vehicle may lack the leverage or traction needed to perform the desired operation since the moment arm extending from the center of the vehicle or other support point to the tilted side of the implement will be fairly large and will laterally extend beyond the traction tires or treads of the vehicle.

An improved tiltable implement configuration is needed in the art. The present invention addresses the described deficiencies of the prior art tilting implement configurations by providing a relatively simple, reliable, and improved design.

### SUMMARY OF THE INVENTION

The invention provides an improved tiltable implement attachment such as a bucket or a blade for a vehicle such as a skid steerer, tractor or the like.

According to one aspect of the invention, the invention includes a tiltable implement attachment for a motor vehicle. The implement could be a number of operative tools such as a bucket, blade, or the like. The tiltable attachment has a hitch assembly including a first locking structure and a second locking structure, wherein the first locking structure is constructed for removably coupling the hitch assembly to the vehicle. The tiltable attachment also includes an implement assembly that has an interlock structure that mates with the second locking structure of the hitch assembly to removably couple the implement assembly to the hitch assembly, wherein the implement assembly is pivotally movable relative to the hitch assembly between an untilted or neutral configuration and a fully tilted configuration. The implement assembly includes an implement working surface that defines a top edge, wherein the implement assembly is pivotally movable relative to the hitch assembly about a pivot point located above the top edge of the working surface of the implement.

According to another aspect of the invention, the invention includes a tiltable implement attachment for a motor vehicle including a right ground engaging traction mechanism (hereinafter simply referred to as a wheel) and a left ground engaging traction mechanism (i.e., wheel). The right wheel defines a right outer edge and the left wheel defines a left outer edge. It will be understood that terminology such as ground engaging mechanism includes wheels, tracks, treads, etc.

The tiltable attachment includes a hitch assembly constructed to couple an implement assembly to the vehicle. The implement assembly is pivotally movable relative to the hitch assembly between an untilted or neutral configuration and a fully tilted configuration. The implement assembly includes an implement with a right end, a left end, and an implement width defined therebetween. The implement may have a width longer than the distance between the right outer edge defined by the right wheel and the left outer edge defined by the left wheel. The tiltable attachment is configured to move the implement assembly in a manner such that the right end of the implement is configured to be positioned inside the right outer edge when the implement assembly is fully tilted to a right side and the left end of the implement is configured to be positioned inside the left outer edge when the implement assembly is fully tilted to a left side.

### BRIEF DESCRIPTION OF THE DRAWINGS

Referring now to the Drawings, wherein like numerals represent like parts throughout the several views:

FIG. 1 is a partially exploded rear perspective view of a tiltable bucket attachment incorporating the principles of the invention;

FIG. 2 is a partially exploded front perspective view of the tiltable bucket attachment of FIG. 1;

FIG. 3 is a partially exploded bottom rear perspective view of the tiltable bucket attachment of FIG. 1;

FIG. 4 is a left side plan view of the tiltable bucket attachment of FIG. 1, as viewed generally from angle 4-4 of FIG. 2;

FIG. 5 is a rear perspective view of the tiltable bucket attachment of FIG. 1, the bucket attachment being shown in a fully assembled configuration;

FIG. 6 is a front perspective view of the tiltable bucket attachment of FIG. 5;

FIG. 7 is a front elevational view of the tiltable bucket attachment of FIG. 5;

FIG. 8 is a left side plan view of the tiltable bucket attachment of FIG. 5, as viewed generally from angle 8-8 of FIG. 7;

FIG. 9 is a front perspective view of a hitch assembly of the tiltable bucket attachment of FIG. 1;

FIG. 10 is a front elevational view of the hitch assembly of FIG. 9;

FIG. 11 is a right side plan view of the hitch assembly of FIG. 9;

FIG. 12 is a top plan view of the hitch assembly of FIG. 9;

FIG. 13 is a rear perspective view of a bucket assembly of the tiltable bucket attachment of FIG. 1;

FIG. 14 is rear elevational view of the bucket assembly of FIG. 13;

FIG. 15 is a cross-sectional view of the bucket assembly of FIG. 13, taken along line 15-15 of FIG. 14;

FIG. 16 is a front plan view of the tiltable bucket attachment of FIG. 5, the bucket attachment shown in an untilted/neutral configuration, the bucket attachment shown in combination with a diagrammatic view of the wheels of a motor vehicle to which the bucket attachment can be attached;

FIG. 17 is a rear plan view of the tiltable bucket attachment of FIG. 16;

FIG. 18 is a front plan view of the tiltable bucket attachment of FIG. 5, the bucket attachment shown fully tilted to the left side, the bucket attachment shown in combination with a diagrammatic view of the wheels of a motor vehicle to which the bucket attachment can be attached;

FIG. 19 is a rear plan view of the tiltable bucket attachment of FIG. 18;

FIG. 20 is a front plan view of the tiltable bucket attachment of FIG. 5, the bucket attachment shown fully tilted to the right side, the bucket attachment shown in combination with a diagrammatic view of the wheels of a motor vehicle to which the bucket attachment can be attached;

FIG. 21 is a rear plan view of the tiltable bucket attachment of FIG. 20; and

FIG. 22 illustrates a diagram generally showing the dynamics of the pivotal movement of the tiltable bucket attachment of FIG. 1.

### DETAILED DESCRIPTION OF THE PREFERRED EMBODIMENT

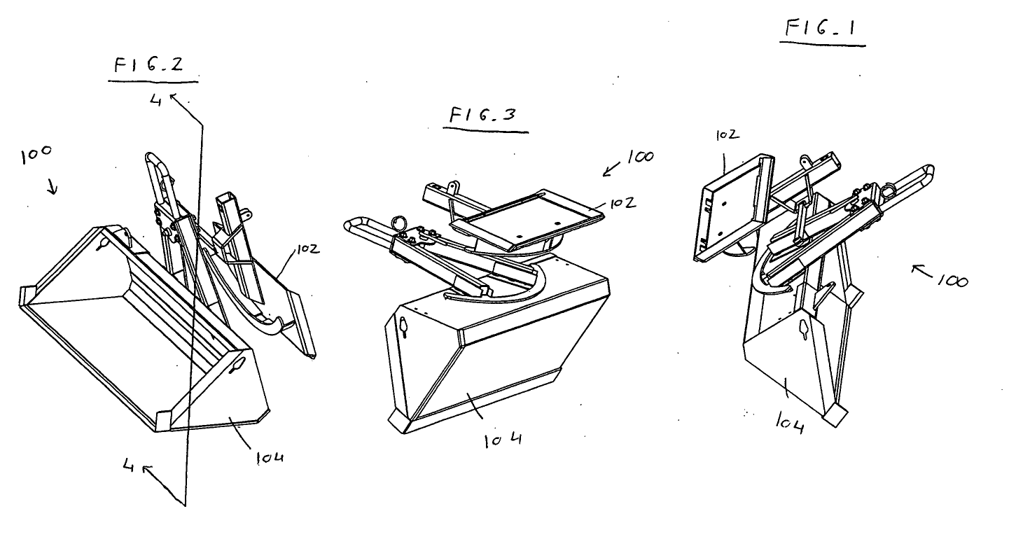

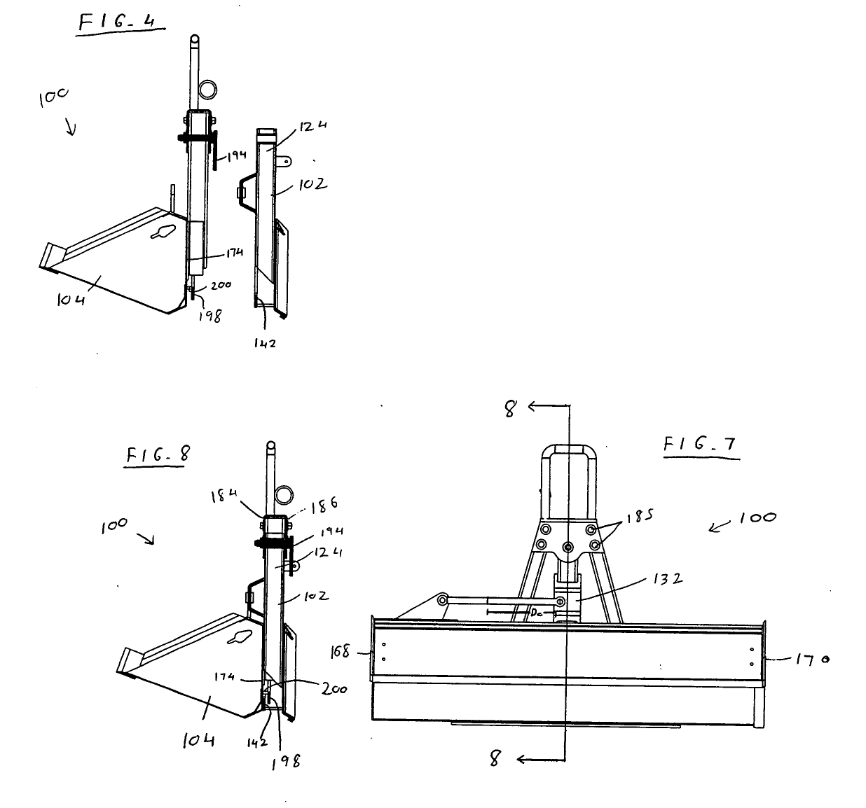

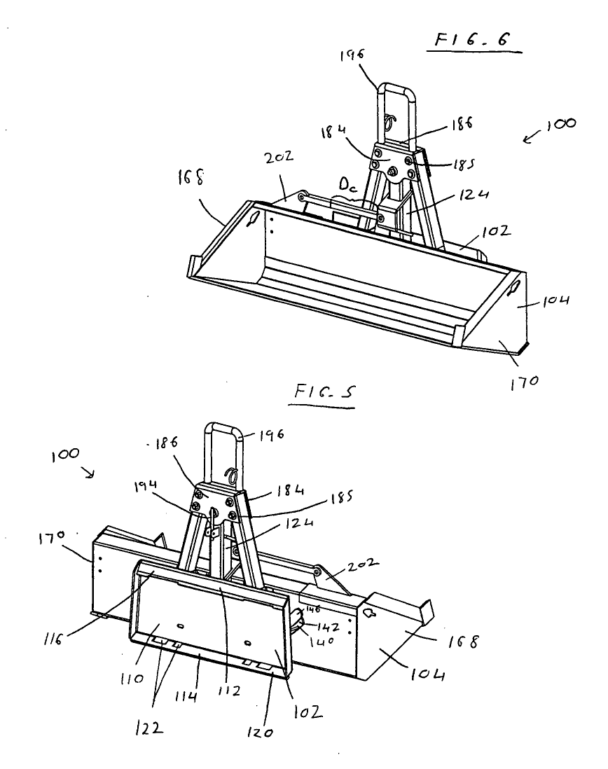

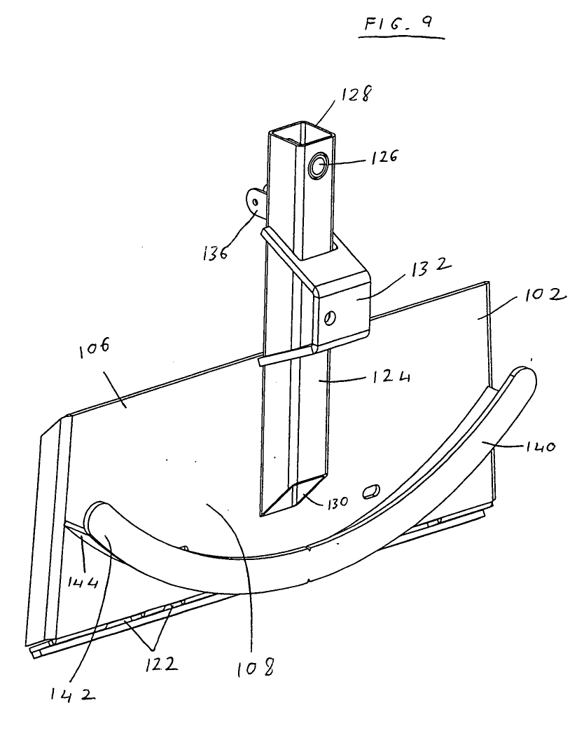

Referring to FIGS. 1-8, there is generally illustrated therein a preferred embodiment of a tiltable implement attachment 100 that incorporates the principles of this invention. The tiltable implement attachment 100 could include a number of operative tools such as a tiltable bucket, blade, or the like. The exemplary tiltable implement attachment 100 described and shown herein is a tiltable bucket attachment, it being understood that any number of different operative tools could be used as an example to describe the aspects of the invention. The tiltable bucket attachment 100 shown and described in this specification is generally constructed for use in motor vehicles such as skid steerers, tractors, or the like that typically include a structure at the front end or the back end of the vehicle for fixedly engaging various attachments. Most vehicle companies have designed their vehicles to include a universal type structure for operatively engaging a plurality of attachments. One common structure found in the art is what is called a toe-heel attachment carrier that is used to engage the hitch portion of the attachments. Most attachment companies have designed their vehicle attachments with a universal type of a hitch so that they can be used with the toe-heel attachment carriers of vehicles of different manufacturers. In this manner, the vehicles can use a variety of attachments manufactured by different companies for a variety of purposes, given that the attachment carriers and the hitch structures found on the attachments contain universal counterparts. An example toe/heel type attachment carrier is described in U.S. application Ser. No. 11/194,108, the entire disclosure of which is incorporated herein by reference.

The preferred embodiment of the tiltable bucket attachment 100 shown and described in this application is constructed to include such a universal hitch structure for use with a toe-heel type attachment carrier found in most vehicles. It should be understood, however, that in other embodiments, the tiltable bucket attachment could include other kinds of attachment structures depending on the type of vehicle and attachment carrier utilized.

Once attached, the tiltable bucket attachment 100 can be operated and moved, generally by hydraulic power, by the vehicle.

The tiltable bucket attachment 100 generally includes a hitch assembly 102 (e.g., a universal type hitch assembly for use with a toe/heel type attachment carrier) and a bucket assembly 104. The hitch assembly 102 may also be referred to as the primary attachment assembly and the bucket assembly 104 may also be referred to as the secondary attachment assembly. In FIGS. 1-4, the hitch assembly 102 and the bucket assembly 104 are shown separated from each other. In FIGS. 5-8, the hitch assembly 102 and the bucket assembly 104 are shown in a fully assembled or engaged configuration. It should be noted that the hitch assembly 102 may be mounted onto the attachment carrier of a vehicle first and the bucket assembly 104 may be coupled to the hitch assembly 102 thereafter, or the hitch and the bucket assemblies 102, 104 may first be coupled together and then attached to the vehicle as one unit.

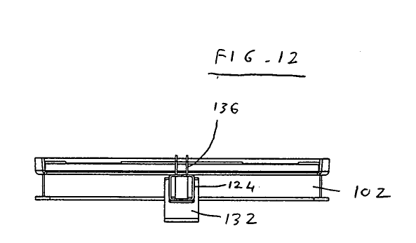

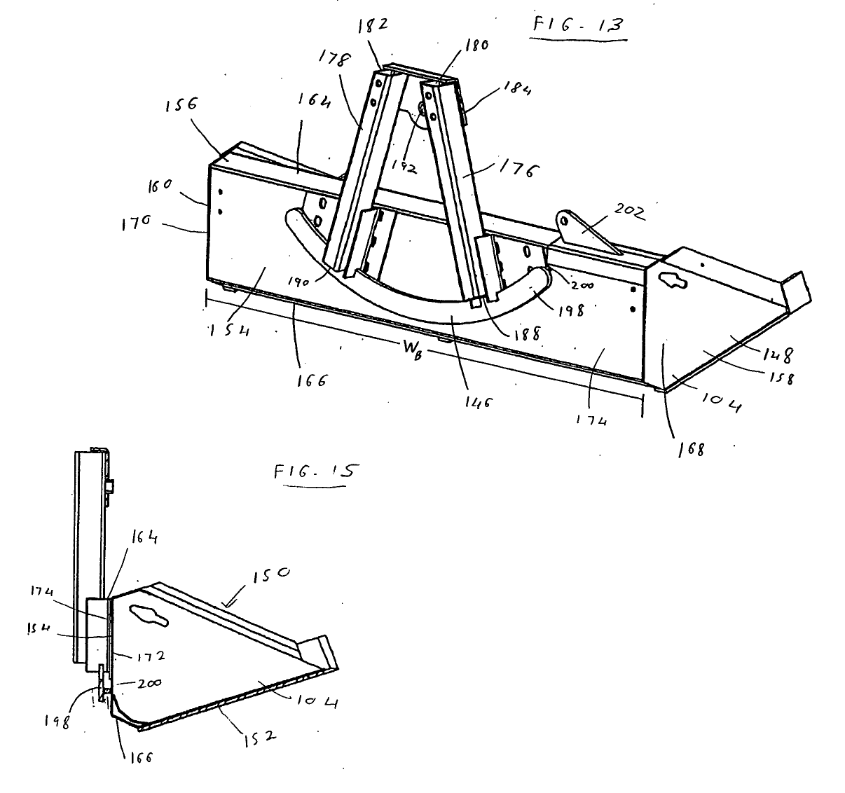

The hitch assembly 102 of the tiltable bucket attachment 100 is shown in FIGS. 9-12. The hitch assembly 102 includes a main plate 106. The main plate 106 includes a front face 108 and a back face 110. At the back face 110 of the main plate 106 there are disposed a top locking structure 112 and a bottom locking structure 114 (see FIG. 5). In the embodiment shown, the top locking structure 112 includes a top plate 116 that protrudes at an angle from the main plate 106 and defines a wedge 118 (see FIG. 11) for receiving the toe of a toe/heel type attachment carrier. The bottom locking structure 114 includes a bottom plate 120 that includes openings 122 for receiving the heel of the toe/heel type attachment carrier. The top and bottom locking structures 112, 114, as mentioned above, are universal structures that are configured to be coupled to a toe/heel type attachment carrier found on a number of loader type vehicles such as skid steerers, tractors, and the like. In certain other embodiments, the top and bottom locking structures 112, 114 may include different configurations.

At the front face 108 of the main plate 106, the hitch assembly 102 includes a support bar 124 that is coupled to the main plate 106. In a preferred embodiment, the support bar 124 is welded to the main plate 106. The support bar 124 is located at the center of the main plate 106 and extends upwardly from the main plate 106. The support bar 124 includes a hole 126 at a top end 128 of the support bar 124. About halfway up from the bottom end 130 of the support bar 124, there is provided a cylinder bracket 132 on the support bar 124. The cylinder bracket 132 is constructed to receive one end of a hydraulic cylinder 134 that is used for tilting the bucket attachment 100. About halfway between the hole 126 at the end of the support bar 124 and the cylinder bracket 132, there is provided a pin bracket 136 on the support bar 124. The pin bracket 136 is used to receive a pin (not shown) to lock the hitch assembly 102 to the bucket assembly 104 once the two assemblies are coupled together. The pin bracket 136 may also be referred to as a pair of clevis tabs.

At the front face 108 of the main plate 106, there is also provided a slide guide 140 located underneath the support bar 124. The slide guide 140 includes an interlock portion 142 and a track portion 144. The interlock portion 142 is generally parallel to the front face 108 of the main plate 106 and is connected to the front face 108 of the main plate 106 via the track portion 144, which extends generally perpendicularly to the front face 108 of the main plate 106. The interlock portion 142 and the track portion 144 are defined by two curved plates that are preferably welded together. As will be discussed in further detail below, the interlock portion 142 is used to slidably engage the slide guide 146 of the bucket assembly 104. The track portion 144 is used to slidably support the slide guide 146 of the bucket assembly 104 as the slide guide 146 of the bucket assembly 104 slides across the track portion 144 of the slide guide 140 of the hitch assembly 102. The bucket attachment 100 is tiltable in a vertical direction and generally parallel to a lateral plane that is defined generally along the front face 108 of the main plate 106.

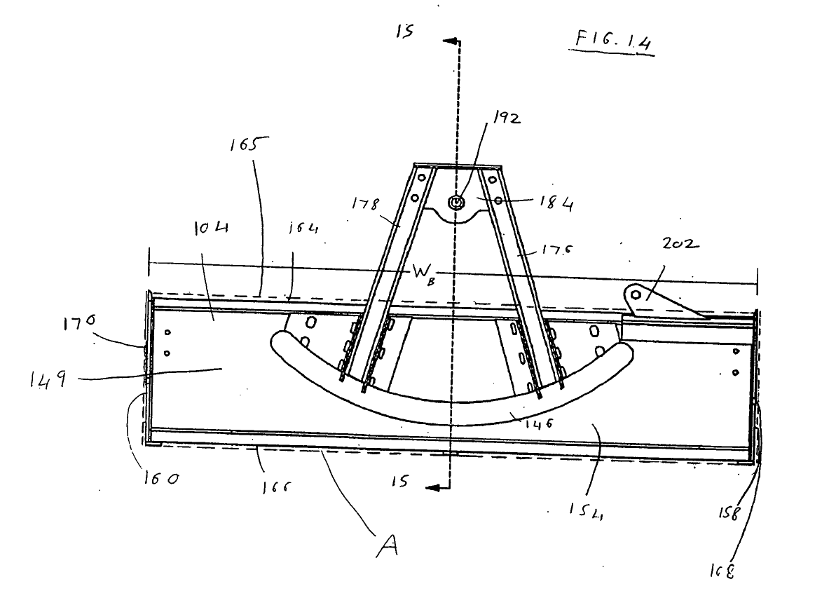

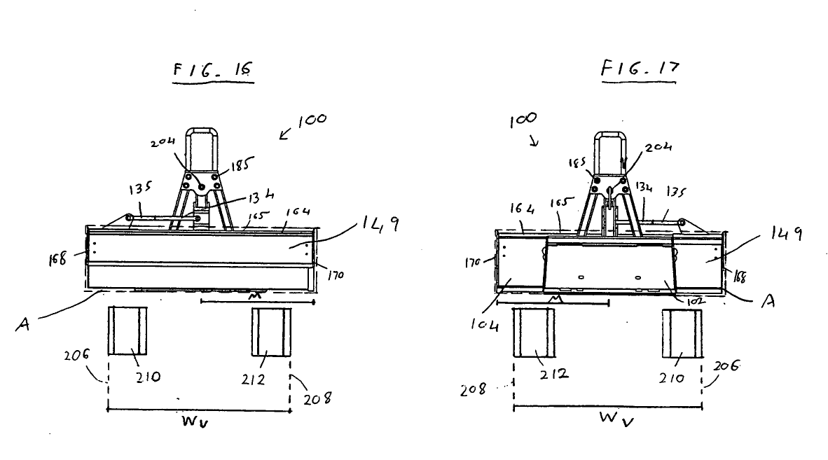

The bucket assembly 104 of the tiltable bucket attachment 100 is illustrated in FIGS. 13-15. The bucket assembly 104 includes a bucket 148. The bucket 148 includes a scoop portion 150 defined by a bottom plate 152, a rear plate 154, a top plate 156, all extending in between two side plates 158, 160. Each side plate may include an opening 162 for receiving chains that may be used for various purposes such as retaining material within the scoop portion of the bucket 148. The bucket 148 preferably has a width W_{B} of about 5 feet to 7 feet. The bucket 148 defines a working surface 149 (see FIG. 14). The working surface 149 is generally defined as the part of the bucket that is used in the desired operation of the bucket. For example, in the embodiment of the bucket 148 shown, the working surface 149 is defined as being located between the bottom plate 152, the top plate 156, and the two side plates 158, 160. The working surface 149 may also be defined as the surface within area A illustrated with dashed lines in FIG. 14. The working surface 149 generally excludes structure such as brackets (e.g., 202 in FIG. 14), guards, tubes, or extensions that may be attached as a separate structure to the top plate 156 for various purposes, and other structure that are generally not used in the main earth working/landscaping operation of the bucket. For different kinds of implements such as a bucket, a blade, etc., the working surface will vary.

The rear plate 154 extends between the top end 164, the bottom end 166 and the right end 168 and the left end 170 of the bucket 148. The rear plate 154 includes a front face 172 and a rear face 174. Mounted on the rear face 174, there is provided two tilt bars 176, 178 and the slide guide 146 located underneath the two tilt bars 176, 178. The two tilt bars 176, 178 are connected together at their respective top ends 180, 182 by a pair of brackets 184, 186. The brackets 184, 186 are fastened to the tilt bars 176, 178 via fasteners 185. There is provided a handle 196 on the bracket 184 for carrying the bucket assembly 104. The two tilt bars 176, 178 angle away from each other in the direction going from their respective top ends 180, 182 to their respective bottom ends 188, 190. The bottom ends 188, 190 of the tilt bars 176, 178 are connected to the rear face 174 of the rear plate 154 of the bucket 148, preferably by welding.

The brackets 184, 186 that are used to connect together the top ends 180, 182 of the tilt bars 176, 178 include holes 192. The holes 192 are configured to align with the hole 126 defined at the top end 128 of the support bar 124 when the hitch assembly 102 is engaged with the bucket assembly 104. When engaged, the support bar 124 is captured between the two brackets 184, 186 and between the tilt bars 176, 178. An L-shaped pivot rod 194 is inserted through the hole 126 at the top end 128 of the support bar 124 and through the holes 192 in the brackets 184, 186 once they are aligned to interlock the hitch assembly 102 to the bucket assembly 104. A portion of the pivot rod 194 is captured in between the clevis tabs 136 with a pin (not shown) to lock the two assemblies 102, 104.

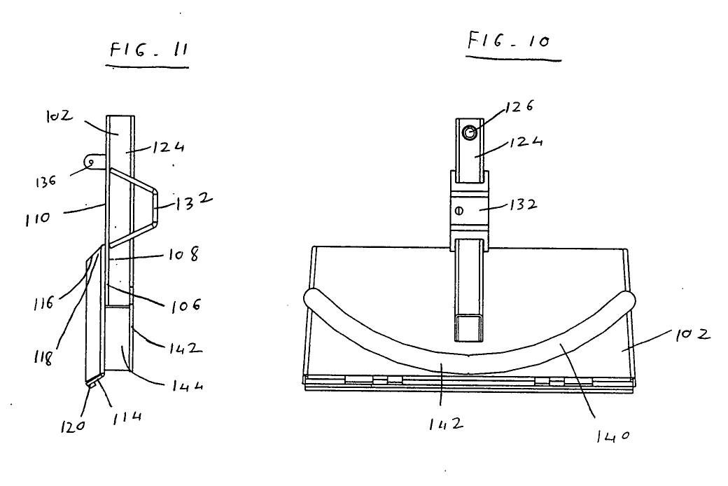

As shown in FIGS. 13 and 14, underneath the tilt bars 176, 178, there is provided the slide guide 146 of the bucket assembly 104. As in the slide guide 140 of the hitch assembly 102, the slide guide 146 of the bucket assembly 104 includes an interlock portion 198 and a track portion 200. As shown in FIGS. 5 and 8, the slide guide 146 of the bucket assembly 104 is configured to be seated on the slide guide 140 of the hitch assembly 102. The interlock portion 142 of the slide guide 140 of the hitch assembly 102 is captured between the interlock portion 198 of the slide guide 146 and the rear face 174 of the bucket 148 of the bucket assembly 104. The interlock portion 198 of the slide guide 146 of the bucket assembly 104 slidably rides along the track portion 144 of the slide guide 140 of the hitch assembly 102 when the bucket assembly 104 is tilted with respect to the hitch assembly 102.

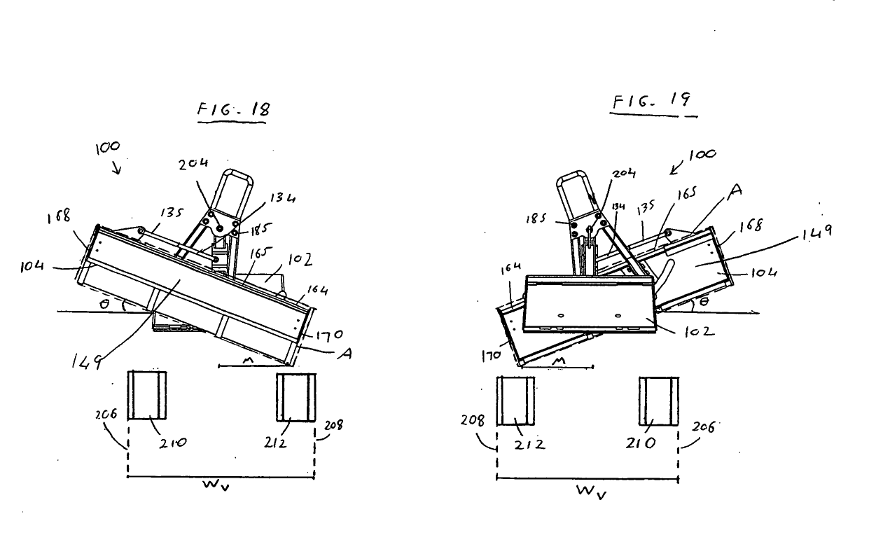

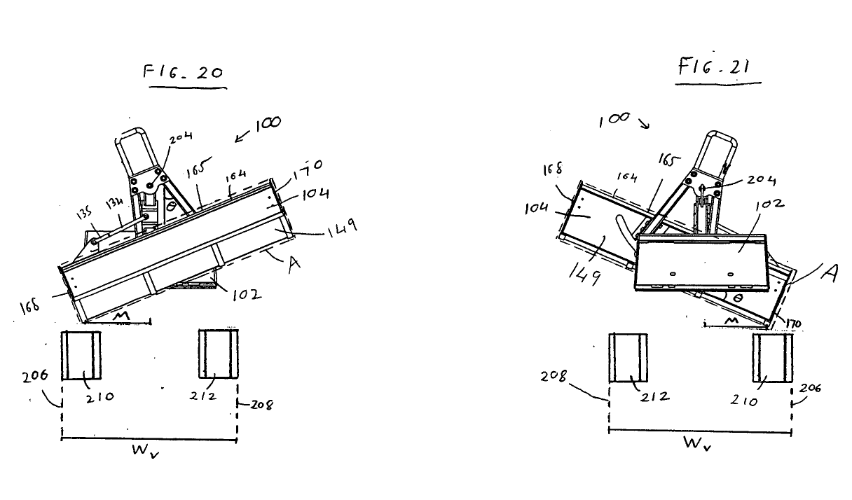

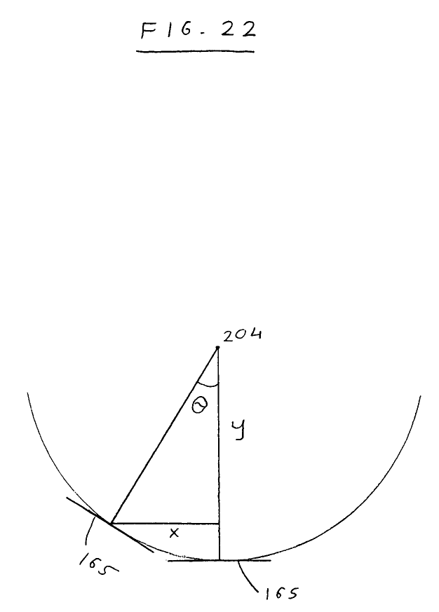

Mounted on the top plate 156 of the bucket 148, there is provided a cylinder bracket 202 that receives the other end of the hydraulic cylinder 134 (shown only diagrammatically in the FIGS.) extending from the cylinder bracket 132 of the support bar 124 of the hitch assembly 102. In a preferred embodiment of the tiltable bucket attachment 100, the hydraulic cylinder 134 has a travel distance D_{c} of 8 inches for a 5 feet bucket. In other embodiments, the hydraulic cylinder 134 can have a travel distance of up to 16 inches. As shown in FIGS. 16-17, the piston 135 of the hydraulic cylinder 134 is generally located at the middle of the cylinder stroke when the bucket attachment 100 is in an untilted configuration. When the bucket 148 is tilted to the left as shown in FIGS. 18 and 19, the piston 135 is extended out of the hydraulic cylinder 134. When the bucket 148 is tilted to the right as shown in FIGS. 20-21, the piston 135 is retracted into the hydraulic cylinder 134. Vehicles of the type that generally receive attachments such as the tiltable bucket attachment 100 of the present invention typically include one or more auxiliary pairs of hydraulically operated and controllable lines powered by the vehicle and extending forwardly therefrom for providing sources of hydraulic power that can be controlled by the operator within the vehicle to energize hydraulic motors, cylinders and the like carried by the attachment mounted to the vehicle. For simplicity in illustrating the invention and for clarity in the figures, such hydraulic lines are not illustrated in the FIGS., but are understood to exist and to extend from and between the vehicle and the hydraulic cylinder 134 provided on the tiltable bucket attachment 100 when the bucket attachment 100 is coupled to a vehicle.

As shown in FIG. 16-21, the bucket assembly 104 is constructed to tilt (i.e., swing, pivot, etc.) with respect to the hitch assembly 102 about the pivot point 204 defined by the hole 126 on the top end of the support bar 124 and the holes 192 in the brackets 184,186 on the top ends 180,182 of the tilt bars 176, 178. The tilt bars 176, 178 pivotally move with respect to the support bar 124, which stays stationary. The slide guide 146 of the bucket assembly 104 slidably moves along the slide guide 140 of the hitch assembly 102 as the bucket assembly 104 is tilted with respect to the hitch assembly 102. In certain embodiments, the bucket assembly is constructed to be tilted at least 10 degrees relative to the hitch assembly 102, as shown by angle θ in FIGS. 18-21. In other more preferred embodiments, the bucket assembly 104 is constructed to tilt between 10 and 45 degrees. Most preferably, the bucket assembly 104 is constructed to tilt up to 30 degrees relative to the hitch assembly 102.

As shown in the FIGS., the pivot point 204 of the bucket attachment is located above the top edge 165 defined by the working surface 149 of the bucket 148. In one embodiment, the pivot point 204 is located approximately 1 foot to 3 feet above the top edge 165 of the working surface 149 (defined within area A) of the bucket 148 when the bucket is in a neutral position. In a preferred embodiment, the pivot point 204 is located approximately 2 feet above the top edge 165 of the working surface 149 of the bucket 148 for a bucket that is 5 feet wide. The dimensions of the bucket assembly 104 and the hitch assembly 102 including the pivot point location should be such that when the bucket attachment 104 is fully tilted to the right or to the left, the tilted end (e.g., the right end 168 or the left end 170 of the bucket 148) should preferably end up inside the outer edges 206, 208 of the vehicle defined by its ground engaging traction mechanisms (i.e., wheels, tracks, treads) 210, 212. Preferably, when the bucket 148 is in the untilted configuration, the right or the left ends 168, 170 of the bucket extend out 2 inches to 6 inches outside of the outer edges 206, 208 of the vehicle. The hitch assembly and the bucket assembly are configured such that when the bucket is tilted from an untilted position to a tilted position, the right or the left end 168, 170 of the bucket can end up positioned within the inside of the outer edges 206, 208 of the vehicle even if the ends 168, 170 extend out 2 inches to 6 inches outside of the outer edges 206, 208 in an untilted position.

In FIGS. 16-21, the bucket attachment 100 is shown in combination with the wheels 210, 212 of a motor vehicle to which the bucket attachment 100 may be attached. The wheels 210, 212 of the vehicle are shown diagrammatically. As shown in FIGS. 18-19, when the bucket attachment 100 is fully tilted to the left, the left end 170 of the bucket 148 ends up within the outer left edge 208 defined by the left wheel 212. And as shown in FIGS. 20-21, when the bucket attachment 100 is fully tilted to the right, the right end 168 of the bucket 148 ends up within the outer right edge 206 defined by the right wheel 210. In this manner, when the bucket attachment 100 is fully tilted, a moment arm M defined from the center of the bucket attachment 100 to an end 168, 170 of the bucket 148 is substantially reduced as compared to the untilted configuration. In prior art tiltable bucket attachment configurations wherein the pivot point is generally located directly behind the center of gravity of the bucket or a little above the center of gravity of the bucket (i.e., within the area of the working surface of the bucket), when the ends of the bucket are tilted, the moment arm remains essentially the same length as compared to the untilted/neutral configuration. The substantially reduced moment arm M of the bucket attachment 100 of the present invention increases the leverage that can be obtained for performing the desired operation when an end of the bucket 148 (e.g., the right end or the left end of the bucket) is tilted.

It should be noted that the location of the height of the pivot point 204 measured from the top edge 165 of the working surface would be partially dictated by the width W_{B} of the bucket utilized. The distance between the pivot point 204 and the top edge 165, as well as the width W_{B} of the bucket 148 and the width of the vehicle Wᵥ should be such that the tilted end of the bucket 148 ends up inside the outer edges 206, 208 of the vehicle defined by the respective wheels 210, 212 when the bucket assembly 104 is tilted. With the pivot point being located above the top edge 165 of the working surface 149 of the bucket 148, even if the width W_{B} of the bucket is longer than the distance between the wheels 210, 212, the right and the left ends 168, 170 of the bucket 148 may still be positioned inside the outer edges 206, 208 defined by the wheels when the bucket assembly is fully tilted. This occurs because the moment arm M defined from the center of the bucket attachment 100 to an end 168, 170 of the bucket 148 is substantially reduced as compared to the untilted configuration when the pivot point is located generally above the top edge 165 of the working surface 149 of the bucket 148. It should be noted that the tilted end of the bucket 148 does not necessarily have to end up inside the outer edges 206, 208 of the vehicle defined by the respective wheels 210, 212 when the bucket is fully tilted, as long as the moment arm M is substantially reduced to provide the desired leverage.

FIG. 22 illustrates a diagram generally showing the dynamics of the pivotal movement of the tiltable bucket attachment 100. As shown, the bucket 148 is movable in a generally circular arc when the pivot point 204 is located above the top edge 165 of the working surface 149 of the bucket 148. Distance y represents for the height of the pivot point 204 from the top edge 165. Angle θ represents the angle the bucket is tilted (i.e., the angle the bucket moves through the circular arc). Distance x represents the change in the length of the moment M mentioned previously. It should be noted that the moment arm M can measured from any arbitrary point and the absolute value of the moment arm M is not as important as the change in the length of the moment arm M (i.e., distance x) that occurs between an untilted/neutral configuration of the bucket and a tilted configuration of the bucket. It should be noted that the distance y is a factor of the ratio of the angle θ to distance x. Depending on the desired configuration of the tiltable implement attachment, the factor constant (k) between y and the two variables x and θ will vary.

It will be appreciated that while a preferred embodiment, description and application of the invention has been disclosed, other modifications of the invention not specifically disclosed or referred to herein will be apparent to those skilled in the art in light of the foregoing description. This invention is intended to provide a specific example of a preferred embodiment structure which clearly discloses the apparatus and its operative principles. Accordingly, the invention is not limited to any particular embodiment or configuration or component parts thereof or to the used of any particular materials for their construction. All alternatives, modifications, and variations of the present invention which fall within the spirit and broad scope of the appended claims are covered.

I claim:

1) An implement attachment for a motor vehicle, the implement attachment comprising:
a hitch assembly including a first locking structure and a second locking structure, the first locking structure being constructed for removably coupling the hitch assembly to the vehicle; and
an implement, the implement including an interlock structure that mates with the second locking structure of the hitch assembly to removably couple the implement to the hitch assembly, the implement including a working surface that defines a top edge, the implement being pivotally tiltable relative to the hitch assembly between an untilted configuration and a fully tilted configuration, the implement being tiltable along a vertical, lateral plane such that sides of the implement move up and down along the vertical plane, the implement being pivotally tiltable relative to the hitch assembly about a pivot point located above the top edge of the working surface of the implement.

2) An implement attachment according to claim 1, wherein the implement is pivotally tiltable relative to the hitch assembly up to about 30 degrees from the untilted configuration to the tilted configuration.

3) An implement attachment according to claim 2, wherein the implement has a width generally of at least about 5 feet.

4) An implement attachment according to claim 1, wherein the implement includes a guide provided at a rear end of the implement configured to intermate with a guide provided at a front end of the hitch assembly for slidably guiding the implement relative to the hitch assembly during the pivotal movement of the implement.

5) An implement attachment according to claim 1, wherein the hitch assembly and the implement are interconnected by a hydraulic cylinder for operably moving the implement relative to the hitch assembly.

6) An implement attachment according to claim 1, wherein the pivot point is located generally between 2 to 3 feet above the top edge of the working surface of the implement.

7) An implement attachment according to claim 1, wherein the implement includes a bucket.

8) An implement constructed for attachment to a motor vehicle defining a front side, a rear side, a right side, and a left side, and including ground engaging traction mechanisms adjacent the right side and the left side of the motor vehicle, the implement comprising:
a working surface that defines a top edge, wherein the implement is configured to be pivotally mounted to the motor vehicle, the implement, once mounted, being configured to be pivotally movable relative to the motor vehicle between an untilted configuration and a fully tilted configuration about a pivot point, wherein the implement is configured to pivotally move along a plane extending generally from the right side of the motor vehicle to the left side of the motor vehicle, wherein the pivot point is located above the top edge of the working surface of the implement.

9) An implement according to claim 8, wherein the implement is pivotally movable relative to the motor vehicle up to about 30 degrees from the untilted configuration to the tilted configuration.

10) An implement according to claim 9, wherein the implement has a width of at least about 5 feet.

11) An implement according to claim 8, wherein the implement is configured to be movable by a hydraulic cylinder operably connected to a hydraulic circuit of the motor vehicle.

12) An implement according to claim 8, wherein the pivot point is located generally between 2 to 3 feet above the top edge of the working surface of the implement.

13) An implement according to claim 8, wherein the implement includes a bucket.

14) A motor vehicle comprising:
a front side, a rear side, a right side, and a left side;
ground engaging traction mechanisms provided adjacent said right side and said left side;
a hitch assembly; and
an implement coupled to the hitch assembly, the implement including a working surface that defines a top edge, the implement being pivotally movable relative to the motor vehicle between an untilted configuration and a fully tilted configuration, wherein the implement is configured to pivot along a plane extending generally from the right side of the motor vehicle to the left side of the motor vehicle, the implement being pivotally movable relative to the motor vehicle about a pivot point located above the top edge of the working surface of the implement.

15) A motor vehicle according to claim 14, wherein the hitch assembly includes a first locking structure and a second locking structure, the first locking structure being configured to removably couple the hitch assembly to the motor vehicle and the second locking structure being configured to removably couple the implement to the hitch assembly.

16) A motor vehicle according to claim 14, wherein the implement is pivotally movable relative to the motor vehicle up to about 30 degrees from the untilted configuration to the tilted configuration.

17) A motor vehicle according to claim 16, wherein the implement has a width of at least about 5 feet.

18) A motor vehicle according to claim 14, wherein the implement includes a guide provided at a rear end of the implement configured to intermate with a guide provided at a front end of the hitch assembly for slidably guiding the implement relative to the hitch assembly during the pivotal movement of the implement.

19) A motor vehicle according to claim 14, wherein the pivot point is located generally between about 2 to 3 feet above the top edge of the working surface of the implement.

20) A motor vehicle according to claim 14, further including a hydraulic cylinder operatively connected to pivotally move the implement, wherein the hydraulic cylinder is adapted to be operatively connected to a hydraulic circuit of the motor vehicle.
